(19) United States
(12) Patent Application Publication
(10) Pub. No.: US 2024/0154409 A1
(43) Pub. Date: May 9, 2024

(54) VOLTAGE SUPPLY SYSTEM, METHOD FOR SUPPLYING A LOAD VIA SUCH A VOLTAGE SUPPLY SYSTEM AND VEHICLE COMPRISING SUCH A VOLTAGE SUPPLY SYSTEM

(71) Applicant: VALEO SYSTEMES DE CONTROLE MOTEUR, Cergy Pontoise (FR)

(72) Inventor: Emmanuel TALON, Cergy Pontoise (FR)

(73) Assignee: VALEO SYSTEMES DE CONTROLE MOTEUR, Cergy Pontoise (FR)

(21) Appl. No.: 18/549,212

(22) PCT Filed: Mar. 8, 2022
(86) PCT No.: PCT/EP2022/055954

§ 371 Date: Sep. 6, 2023

(30) Foreign Application Priority Data
Mar. 8, 2021 (FR) 2102234

(51) Int. Cl. H02J 1/08; B60R 16/033

(52) U.S. Cl. CPC H02J 1/082; B60R 16/033; B60L 58/20; H02J 2310/48

(57) ABSTRACT

A supply system includes first, second and third supply terminals, a voltage regulating terminal, and an output terminal electrically connected to the voltage regulating terminal. A first battery generates a first supply voltage between the first and second terminals, and a second battery generates a second supply voltage between the second and third terminals. The second battery is connected in series with the first battery to deliver a first output voltage between the third and first supply terminals. A DC-to-DC voltage converter, in a first operating mode, converts the first output voltage into a second output voltage between the regulating terminal and the first supply terminal, the second output voltage being lower than the first output voltage, and in a second operating mode, it does not regulate the voltage between the regulating terminal and the first supply terminal.

The present invention relates to a voltage supply system, to a motor vehicle comprising such a voltage supply system and to a method of supply of a load with a supply system comprised in a vehicle.

The present invention may in particular be applied in the field of hybrid motor vehicles.

Voltage supply systems are known in the prior art, these comprising:
a first supply terminal, a second supply terminal and a third supply terminal that are separate from one other,
a voltage regulation terminal,
an output terminal,
an electrical connection, a wired connection for example, between said voltage regulation terminal and said output terminal, the electrical connection having a link resistance,
a first battery generating a first supply voltage across the first supply terminal and the second supply terminal,
a second battery generating a second supply voltage across the second input terminal and the third supply terminal, the second battery being connected in series with the first battery so as to deliver a first output voltage across the third supply terminal and the first supply terminal, and
a DC/DC voltage converter configured, in a first operating mode, to convert said first output voltage into a second output voltage across said regulation terminal and said first supply terminal, said second output voltage being lower than said first output voltage, and configured, in a second operating mode, not to regulate the voltage across said regulation terminal and said first supply terminal,
   the voltage supply system being able to generate a third output voltage across the output terminal and the first supply terminal.

However, in such a voltage supply system, the first battery is more highly stressed than the second battery, this requiring the first battery to be over-sized, for example by doubling its number of cells, in order to guarantee it a lifespan equivalent to that of the second battery.

The aim of the invention is to at least partly mitigate the aforementioned problem.

Therefore, according to a first aspect of the invention, a voltage supply system is provided, this voltage supply system comprising:
a first supply terminal, a second supply terminal and a third supply terminal that are separate from one other,
a voltage regulation terminal,
an output terminal;
an electrical connection, a wired connection for example, between said voltage regulation terminal and said output terminal, the electrical connection having a connection resistance,
a first battery generating a first supply voltage across said first supply terminal and said second supply terminal,
a second battery generating a second supply voltage across said second input terminal and said third supply terminal, said second battery being connected in series with said first battery so as to deliver a first output voltage across said third supply terminal and said first supply terminal,
a DC/DC voltage converter configured, in a first operating mode, to convert said first output voltage into a second output voltage across said regulation terminal and said first supply terminal, said second output voltage being lower than said first output voltage, and configured, in a second operating mode, not to regulate the voltage across said regulation terminal and said first terminal supply,
a connection switch connecting said second supply terminal and said output terminal,
a connection resistance connected in parallel with said connection switch, and
   said supply system being able to generate a third output voltage across said output terminal and said first supply terminal.

This voltage supply system is characterized in that a connection switch in parallel with a connection resistance connects the second supply terminal and the output terminal.

By virtue of this technical feature, the third output voltage is generated either directly by the first battery when the connection switch is closed, or simultaneously by the first battery and by the DC/DC voltage converter when the connection switch is open. In the latter case, the connection resistance makes it possible to ensure an asymmetrical distribution of the current delivered by the first battery and by the DC/DC voltage converter and therefore an asymmetrical contribution of the DC/DC voltage converter and of the first battery. In other words, when the connection switch is open, the DC/DC voltage converter will deliver more current than the first battery, this contributing to limiting direct use of the first battery, thus allowing its size in terms of cells to be limited while preserving its lifespan.

A voltage supply system according to the invention may further comprise one or more of the following optional features, implemented individually or in any technically possible combination.

According to a first feature, the supply system further comprises a unit for controlling the voltage converter.

According to another feature, the supply system further comprises means for controlling the connection switch.

According to another feature, the connection resistance is a resistor. In other words, the connection resistance is a dipole satisfying Ohm's law.

According to yet another feature, the supply system further comprises a first capacitor connecting the third supply terminal to the first supply terminal.

According to yet another feature, the supply system further comprises a second capacitor connecting the output terminal to the first supply terminal.

According to yet another feature, the supply system further comprises a second capacitor connecting the voltage regulation terminal to the first supply terminal.

According to yet another feature, the connection switch is normally closed.

A normally closed switch is a switch that allows current to flow through it when the DC/DC voltage converter is inactive. In other words, the DC/DC voltage converter does not regulate the voltage across the regulation terminal and the first supply terminal, because it is not operating (i.e. it is inactive or faulty).

In other words, the connection switch is closed when the DC/DC voltage converter is not working.

According to yet another feature, the connection switch comprises a normally closed transistor, for example a p-channel FET.

A normally closed transistor is a transistor that allows current to flow through it when the DC/DC voltage converter is inactive.

For example, the p-channel FET is an enhancement transistor the gate of which is at ground and the source of which is at a DC supply voltage, for example the first DC supply voltage.

According to yet another feature, the connection switch comprises a normally open transistor, for example an n-channel FET, and a charge-pump circuit able to apply a control voltage to said normally open transistor.

According to yet another feature, the connection switch comprises a normally open transistor, for example an n-channel FET, and a charge-pump circuit able to apply a control voltage to said normally open transistor to close said normally open transistor when the voltage converter is not operating.

A normally open transistor is a transistor that does not allow current to flow through it when the DC/DC voltage converter is inactive.

According to yet another feature, the connection switch is configured to be closed when the voltage converter is operating in the second operating mode.

According to yet another feature, the connection switch comprises a MOSFET, for example one made of silicon or of silicon carbide, or a FET made of gallium nitride or a HEMT made of gallium nitride.

According to yet another feature, the electrical connection between the output terminal and the voltage regulation terminal has a link resistance lower than 1 mΩ, preferably lower than or equal to 0.8 mΩ, and even more preferably lower than or equal to 0.6 mΩ.

According to yet another feature, the connection resistance is comprised between 1 and 100 mΩ, and preferably between 5 and 80 mΩ.

According to yet another feature, the connection resistance is from 2 to 200 times higher, and preferably from 10 to 160 times higher, than the connection resistance of the electrical connection between the output terminal and the regulation terminal.

According to yet another feature, the DC/DC voltage converter further comprises one or more switching cells, said or each of said switching cells comprising:
a switching arm comprising a high-side switch and a low-side switch that are connected to each other at a midpoint, said switching arm being connected between said first supply terminal and said third supply terminal, and
an inductor connected between said midpoint of said switching arm and said regulation terminal.

According to yet another feature, the high-side switch and/or said low-side switch is a MOSFET, for example one made of silicon or of silicon carbide, or a FET made of gallium nitride or a HEMT made of gallium nitride.

According to yet another feature, the supply system is configured in a first mode of use of the supply system to close the connection switch and put the voltage converter into the second operating mode, and in a second mode of use of the supply system to open the connection switch and put the voltage converter into the first operating mode.

According to yet another feature, the supply system is configured, in a third mode of use of the supply system, to close the connection switch and put the voltage converter into the first operating mode.

According to a second aspect of the invention, a vehicle comprising a supply system according to the first aspect of the invention is also provided.

The vehicle according to the second aspect of the invention may further comprise the following optional feature whereby the vehicle further comprises a first load connected between the third voltage supply terminal and the first voltage supply terminal and a second load connected between the output terminal and the first voltage supply terminal or between the regulation terminal and the first voltage supply terminal.

According to a third aspect of the invention, a method of supply of a second load by means of a third voltage output by a supply system according to the first aspect of the invention or by a supply system comprised in a vehicle according to the second aspect of the invention, said supply method comprising the steps of:
in a first mode of use of the supply system, closing the connection switch and putting the voltage converter into the second operating mode, and
in a second mode of use of the supply system, opening the connection switch and putting the voltage converter into the first operating mode.

The supply method according to the third aspect of the invention may further comprise the following optional feature whereby the supply method further comprises the steps of, in a third mode of use of the supply system, closing the connection switch and putting the voltage converter into the first operating mode.

The invention will be better understood by means of the following description, which is given merely by way of an example and with reference to the appended drawings, in which:

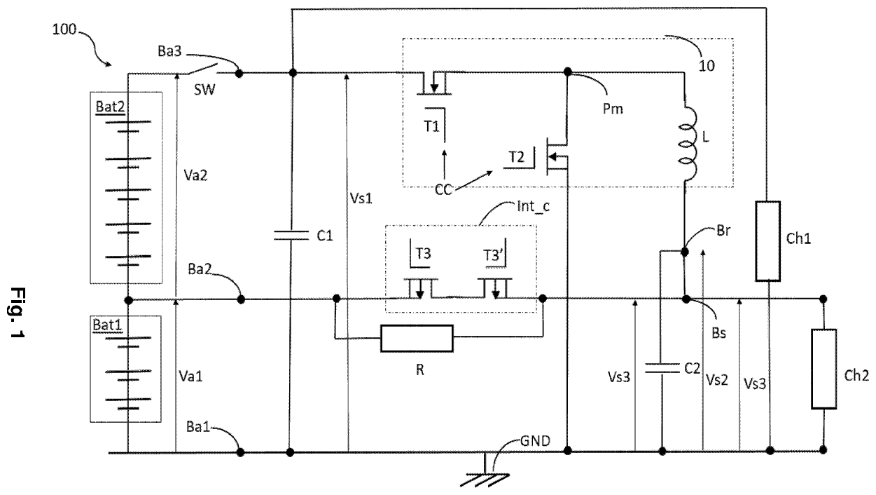

FIG. 1 schematically shows a voltage supply system 100 in a first embodiment of the invention, and

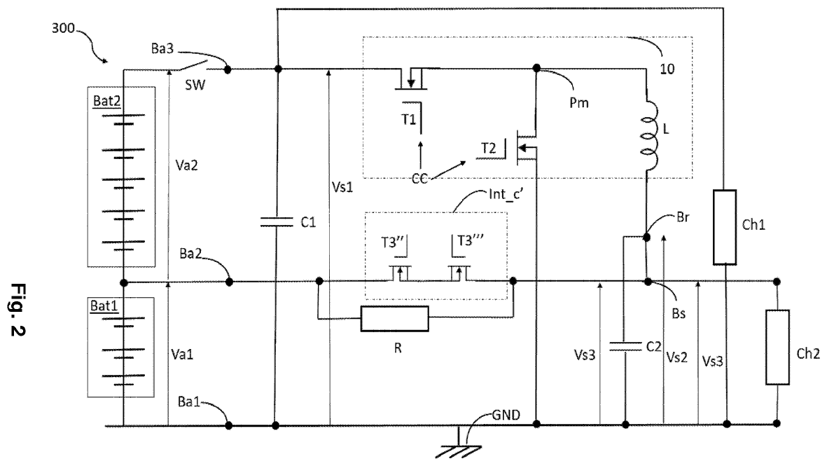

FIG. 2 schematically shows a voltage supply system 300 in a second embodiment of the invention.

With reference to FIG. 1, a voltage supply system 100 intended to equip, for example, a motor vehicle will now be described.

The voltage supply system 100 firstly comprises a DC/DC voltage converter 10, a first supply terminal Ba1, a second supply terminal Ba2 and a third supply terminal Ba3.

The three supply terminals Ba1, Ba2 and Ba3 are separate from one another and the first supply terminal Ba1 is electrically connected to an electrical ground GND.

The voltage supply system 100 also comprises a voltage regulation terminal Br and an output terminal Bs, the output terminal Bs being electrically connected, for example by a wired connection, to the voltage regulation terminal Br. As a variant, the voltage regulation terminal Br and the output terminal Bs may be electrically connected by a low-resistance busbar or by any connection means having a low resistance, for example one lower than 1 mΩ.

Thus, there is a link resistance Rc between the voltage regulation terminal Br and the output terminal Bs due to the electrical connection between the output terminal Bs and the regulation terminal Br.

In the example described here, this resistance is of the order of 0.5 mΩ.

The voltage supply system 100 further comprises a first electrical power source designed to deliver a first DC supply voltage Va1. This first electrical power source is connected between the first supply terminal Ba1 and the second supply terminal Ba2. In the example described, this first electrical power source is a battery Bat1 designed to deliver, for example, a voltage of 12 V.

The voltage supply system 100 further comprises a safety switch SW and a second electrical power source designed to deliver a second DC supply voltage Va2. This second electrical power source is connected to the second supply terminal Ba2 and via the safety switch SW to the third supply terminal Ba3. In the example described, this second electrical power source is a battery Bat2 designed to deliver, for example, a voltage of 36 V.

In the example described here, the battery Bat1 comprises three cells or accumulators in series and the battery Bat2 comprises five cells or accumulators in series. For example, the cells of the batteries Bat1 and of the battery Bat2 are lithium-ion cells or even lithium-iron-phosphate (LFP) cells or indeed lithium nickel-manganese-cobalt (NMC) cells.

Furthermore, the first electrical power source and the second electrical power source are connected in series so that the first DC supply voltage Va1 and the second DC supply voltage Va2 add to deliver a first output voltage Vs1 across the third supply terminal Ba3 and the first supply terminal Ba1. In other words, in the example described here, the first battery Bat1 and the second battery Bat2 are connected in series, i.e. the plus pole of the first battery Bat1 is connected to the minus pole of the second battery Bat2 so as to deliver a first output voltage Vs1 of 48V across the third supply terminal Ba3 and the first supply terminal Ba1.

The voltage converter 10 further comprises one or more voltage conversion cells. The one or more voltage conversion cells are connected to the first supply terminal Ba1, to the third supply terminal Ba3 and to the voltage regulation terminal Br with a view to achieving a conversion between the first output voltage Vs1 and a second output voltage Vs2 across the voltage regulation terminal Br and the first supply terminal Ba1, the second output voltage Vs2 being lower than the first output voltage Vs1.

In the example described, the voltage converter 10 comprises a single voltage conversion cell and this conversion cell is a switching cell. It for example comprises a switching arm comprising a high-side switch T1 and a low-side switch T2 that are connected to each other at a midpoint Pm. The switching arm is connected between the third supply terminal Ba3 and the first supply terminal Bel to receive the first output voltage Vs1. This switching cell further comprises an inductor L connecting the midpoint Pm to the voltage regulation terminal Br.

The switching cell is designed to be controlled by commands CC so as to alternately open and close the high-side and low-side switches in opposition to each other, so as to generate the second output voltage Vs2 from the first output voltage Vs1. The commands CC are generated by a unit (not shown in FIG. 1) for controlling said voltage converter 10.

Since the output terminal Bs is electrically connected to the voltage regulation terminal Br, it follows that a third output voltage Vs3 is generated across the output regulation terminal Bs and the first supply terminal Ba1. This third output voltage Vs3 is substantially equal, to within the voltage drop due to the link resistance between the voltage regulation terminal Br and the output terminal Bs, to the second output voltage Vs3.

The voltage supply system 100 further comprises a capacitor C1 connecting the third supply terminal Ba3 to the first supply terminal Ba1 and a capacitor C2 connecting the regulation terminal Br to the first supply terminal Ba1. As a variant, the capacitor C2 may be connected between the output terminal Bs and the first supply terminal Ba1.

The voltage supply system 100 also comprises a connection switch Int_c and a connection resistance R connected in parallel between the second supply terminal Ba2 and the output terminal Bs. The connection switch Int_c is controlled by control means (not shown in FIG. 1).

In the example described here, the connection resistance R is comprised between 5 and 80 mΩ. In other words, the connection resistance R has a value from 10 to 160 times higher than the link resistance Rc.

Each switch SW, T1, T2 and Int_c comprises first and second main terminals and a control terminal intended to selectively open and close the switch SW, T1, T2 and Int_c between its two main terminals depending on a control signal applied to it.

If in the absence of a control signal on the control terminal—for example, when the switch is a transistor, in the absence of a control voltage on the gate of this transistor—the switch is closed, it will be said to be a normally closed switch. Otherwise, the switch will be said to be normally open.

The switches SW, T1, T2 and Int_c are for example transistors such as metal-oxide field-effect transistors, generally designated by the acronym MOSFETs.

In the example described here, the switches SW, T1 and T2 are n-channel MOSFETs and the switch Int_c takes the form of two transistors T3 and T3′ mounted back to back (via an electrical connection between their respective source or alternatively via an electrical connection between their respective drain), the two transistors T3 and T3′ being p-channel MOSFETs that are controlled open or closed simultaneously.

As a variant, the switch Int_c may take the form of a single p-channel MOSFET T3.

In other words, the switches SW, T1, T2 are normally open switches and the switch Int_c is a normally closed switch.

The motor vehicle comprising the voltage supply system 100 also comprises a first load Ch1 connected between the third voltage supply terminal Ba3 and the first voltage supply terminal Ba1 and a second load Ch2, for example a radio or a light, connected between the output terminal Bs and the first voltage supply terminal Ba1. In other words, the motor vehicle comprises two on-board networks, the first being supplied with the first output voltage Vs1 and the second being supplied with the second output voltage Vs2. In the example described here, the first on-board network is supplied with a voltage of 48 V and the second on-board network is supplied with a voltage of 12 V.

A method for supplying the second load Ch2 by means of the supply system 100 comprised in the motor vehicle will now be described.

In the example described here, the motor vehicle comprises a starter supplied by the second on-board network.

In a first mode of use MOD1 of the supply system 100, used for example when the vehicle is stopped, i.e. the electric motor and/or internal combustion engine that drives the motor vehicle are/is stopped, the means for controlling the connection switch Int_c keep the latter in a closed state, i.e. the transistors T3 and T3′ are in an on state, the switch SW is open and the unit for controlling the voltage converter 10 operates the latter in the second operating mode, i.e. the voltage converter 10 does not regulate the voltage across the regulation terminal Br and the first supply terminal Ba1.

In this first mode of use, the first on-board network is supplied solely by the battery Bat1. In other words, the third output voltage Vs3 supplied to the second load Ch2 is delivered solely by the first battery Bat1.

In a second mode of use MOD2 of the supply system 100, used for example when the engine and/or motor of the vehicle is running, the means for controlling the connection switch Int_c keep the latter in an open state, i.e. the transistors T3 and T3′ are in an off state, the switch SW is closed and the unit for controlling the voltage converter 10 operates the latter in the first operating mode, i.e. the voltage converter 10 converts the first output voltage Vs1 into a second output voltage Vs2 across the regulation terminal Br and the first supply terminal Ba1.

In this second mode of use MOD2, the battery Bat1 is connected to the output terminal Bs via the connection resistance R. In this second operating mode MOD2, the ratio between the link resistance Rc and the connection resistance R results in an asymmetrical distribution of the current delivered by the battery Bat1 and by the voltage converter 10, and therefore to an asymmetrical contribution of the voltage converter 10 and of the battery Bat1. In other words, in the example described, the voltage converter 10 will contribute from 10 to 160 times more than the battery Bat1 to the regulation of the voltage of the second output voltage Vs2, this contributing to limiting direct use of the battery Bat1, thus making it possible to limit its size in terms of cells while preserving its lifespan.

In a third mode of use MOD3 of the supply system 100, used for example when the engine and/or motor is started by means of the starter supplied by the second on-board network, the means for controlling the connection switch Int_c keep the latter in a closed state, i.e. the transistors T3 and T3′ are in an on state, the switch SW is closed and the unit for controlling the voltage converter 10 begins to operate the latter in the first operating mode, i.e. the voltage converter 10 converts the first output voltage Vs1 into a second output voltage Vs2 across the regulation terminal Br and the first supply terminal Ba1.

In this third mode of use MOD3, the battery Bat1 is directly connected to the output terminal Bs so that the battery Bat1 is able to contribute to delivering, in the same way as the voltage converter 10, the power required to start the engine of the vehicle.

With reference to FIG. 2, a second embodiment of the invention will now be described. Elements that are identical or similar to those of the first embodiment have been designated by the same reference number in the description of this second embodiment.

The voltage supply system 300 in this second embodiment differs from the voltage supply system 100 of the first embodiment in that the connection switch Int_c′ takes the form of two transistors T3″ and T3′″ connected back to back (via an electrical connection between their respective source or alternatively via an electrical connection between their respective drain) and a charge-pump circuit.

The two transistors T3″ and T3′″ are n-channel MOSFETs controlled open or closed simultaneously by their control means, said control means comprising the charge-pump circuit, the latter being able to apply a control voltage to the gate of the normally open transistors T3″, T3′″.

In other words, association of the normally open transistors T3″, T3′″ and of the charge-pump circuit produces a normally closed switch Int_c′.

As a variant; the switch Int_c′ may be a single n-channel MOSFET T3″.

It will moreover be noted that the invention is not limited to the embodiments described above. Specifically, it will be obvious to those skilled in the art that various modifications may be made to the embodiments described above, in the light of the teaching that has just been disclosed.

For example, in the embodiment of FIG. 1 or FIG. 2, the DC/DC converter 10 comprises a single cell. Of course, the number of cells C could be different without departing from the scope of the present invention. Thus, it is possible to use a plurality of cells of similar or identical structures placed in parallel. The number N of cells may for example be comprised between 2 and 12, for example being 2, 3, 4, 5 or 6.

Use of a plurality of cells may make it possible to reduce constraints on the switches. An interleaved converter is then spoken of because the cells of the voltage converter all lead to the same output capacitor C2 with a phase shift of T/N between the commands of the switches of each successive cell, where T is the period of the operating cycle of the converter. In other words, the duty cycle within each of the cells is identical but the commands of the transistors are out of phase by T/N from one cell to another.

Furthermore, in the examples described above, the switches SW, T1, T2, T3, T3′, T3″, T3′″ are MOSFETs, for example made of silicon (Si-MOSFETs) or silicon carbide (SiC-MOSFETs).

As a variant, these transistors may be insulated-gate bipolar transistors (IGBTs) or field-effect transistors (FETs) made of gallium nitride (GaN-FETs), or even high-electron-mobility transistors (HEMTs) for example made of gallium nitride.

Of course, other DC/DC voltage-converter topologies may be used, in a first operating mode, to convert the first output voltage into a second output voltage across the regulation terminal and the first supply terminal, the second output voltage being lower than the first output voltage, and, in a second operating mode, not to regulate the voltage across the regulation terminal and the first terminal supply.

In the detailed presentation of the invention that was given above, the terms that were used must not be interpreted as limiting the invention to the embodiments disclosed in the present description, but must be interpreted as including all equivalents conceivable by a person skilled in the art applying her or his general knowledge to the implementation of the teaching that has just been disclosed.

1. A voltage supply system comprising:
a first supply terminal, a second supply terminal and a third supply terminal that are separate from one other,
a voltage regulation terminal,
an output terminal,
an electrical connection, a wired connection for example, between said voltage regulation terminal and said output terminal, said electrical connection having a link resistance,
a first battery generating a first supply voltage across said first supply terminal and said second supply terminal,
a second battery generating a second supply voltage across said second input terminal and said third supply terminal, said second battery being connected in series with said first battery so as to deliver a first output voltage across said third supply terminal and said first supply terminal,
a DC/DC voltage converter configured, in a first operating mode, to convert said first output voltage into a second output voltage across said regulation terminal and said first supply terminal, said second output voltage being lower than said first output voltage, and configured, in a second operating mode, not to regulate the voltage across said regulation terminal and said first supply terminal,
a connection switch connecting said second supply terminal and said output terminal, and
a connection resistance connected in parallel with said connection switch,
said supply system being able to generate a third output voltage across said output terminal and said first supply terminal.

2. The supply system as claimed in claim 1, wherein the connection switch is normally closed.

3. The supply system as claimed in claim 2, wherein the connection switch comprises a normally closed transistor, for example a p-channel FET.

4. The supply system as claimed in claim 1, wherein the connection switch comprises a normally open transistor, for example an n-channel FET, and a charge-pump circuit able to apply a control voltage to said normally open transistor.

5. The supply system as claimed in claim 1, wherein the connection switch (Int_c, Int_c′) is configured to be closed when the voltage converter is operating in the second operating mode.

6. The supply system as claimed in claim 1, wherein said connection resistance is from 2 to 200 times higher, and preferably from 10 to 160 times higher, than said link resistance of the electrical connection between said output terminal and said regulation terminal.

7. The supply system as claimed in claim 1, wherein the DC/DC voltage converter further comprises one or more switching cells, said or each of said switching cells comprising:
a switching arm comprising a high-side switch and a low-side switch that are connected to each other at a midpoint, said switching arm being connected between said first supply terminal and said third supply terminal, and
an inductor connected between said midpoint of said switching arm and said regulation terminal.

8. The supply system as claimed in claim 7, wherein said high-side switch and/or said low-side switch is a MOSFET, for example one made of silicon or of silicon carbide, or a FET made of gallium nitride or a HEMT made of gallium nitride.

9. A vehicle comprising a supply system as claimed in claim 1.

10. The vehicle as claimed in claim 9, comprising a first load connected between the third voltage supply terminal and the first voltage supply terminal and a second load connected between the output terminal and the first voltage supply terminal or between the regulation terminal and the first voltage supply terminal.

11. A method of supply of a second load by means of a third voltage output by a supply system as claimed in claim 1, said supply method comprising the steps of:
in a first mode of use of the supply system, closing the connection switch and putting the voltage converter into the second operating mode, and
in a second mode of use of the supply system, opening the connection switch and putting the voltage converter into the first operating mode.

12. The method as claimed in claim 11, wherein said supply method further comprises the steps of, in a third mode of use of the supply system, closing the connection switch and putting the voltage converter into the first operating mode.

13. The supply system as claimed in claim 2, wherein the connection switch comprises a normally open transistor for example an n-channel FET, and a charge-pump circuit able to apply a control voltage to said normally open transistor.

14. The supply system as claimed in claim 2, wherein the connection switch is configured to be closed when the voltage converter is operating in the second operating mode.

15. The supply system as claimed in claim 2, wherein said connection resistance is from 2 to 200 times higher, and preferably from 10 to 160 times higher, than said link resistance of the electrical connection between said output terminal and said regulation terminal.

16. The supply system as claimed in claim 2, wherein the DC/DC voltage converter further comprises one or more switching cells, said or each of said switching cells comprising:
a switching arm comprising a high-side switch and a low-side switch that are connected to each other at a midpoint, said switching arm being connected between said first supply terminal and said third supply terminal, and
an inductor connected between said midpoint of said switching arm and said regulation terminal.

17. A vehicle comprising a supply system as claimed in claim 2.

18. A method of supply of a second load by means of a third voltage output by a supply system as claimed in claim 2, said supply method comprising the steps of:
in a first mode of use of the supply system, closing the connection switch and putting the voltage converter into the second operating mode, and
in a second mode of use of the supply system, opening the connection switch and putting the voltage converter into the first operating mode.

19. The supply system as claimed in claim 3, wherein the connection switch comprises a normally open transistor for example an n-channel FET, and a charge-pump circuit able to apply a control voltage to said normally open transistor.

20. The supply system as claimed in claim 3, wherein the connection switch is configured to be closed when the voltage converter is operating in the second operating mode.
